(19) United States
(12) Patent Application Publication
(10) Pub. No.: US 2024/0275639 A1
(43) Pub. Date: Aug. 15, 2024

(54) COMMUNICATION APPARATUS, COMMUNICATION SYSTEM, COMMUNICATION METHOD, CONTROL CIRCUIT, AND STORAGE MEDIUM

(71) Applicant: Mitsubishi Electric Corporation, Tokyo (JP)

(72) Inventors: Kyohei AMANO, Tokyo (JP); Akinori OHASHI, Tokyo (JP); Ryosuke NAKAMURA, Tokyo (JP); Yuta HORI, Tokyo (JP)

(73) Assignee: Mitsubishi Electric Corporation, Tokyo (JP)

(21) Appl. No.: 18/644,220

(22) Filed: Apr. 24, 2024

Related U.S. Application Data
(63) Continuation of application No. PCT/JP2021/043475, filed on Nov. 26, 2021.

(51) Int. Cl. H04L 25/02

(52) U.S. Cl. CPC H04L 25/0212; H04L 25/0224

(57) ABSTRACT

A communication apparatus includes: a despreading unit that performs despreading processing on a received signal subjected to direct spread processing; a signal detection unit that detects a plurality of signals included in the received signal subjected to the despreading processing; a delay amount estimation unit that estimates an amount of delay in each of the plurality of detected signals; a pilot signal extraction unit that extracts a subcarrier including a pilot signal from the received signal based on the estimated amounts of delay; a spreading unit that performs direct spread processing on the extracted pilot signal by using a spreading sequence used by a source of transmission of the received signal for performing direct spread processing; and a transmission path estimation processing unit that performs transmission path estimation processing based on the pilot signal subjected to the direct spread processing.

### CROSS-REFERENCE TO RELATED APPLICATION

This application is a continuation application of International Application PCT/JP2021/043475, filed on Nov. 26, 2021, and designating the U.S., the entire contents of which are incorporated herein by reference.

### BACKGROUND OF THE INVENTION

### 1. Field of the Invention

The present disclosure relates to a communication apparatus, a communication system, a communication method, a control circuit, and a storage medium.

### 2. Description of the Related Art

In wireless communication, demodulation performance in a receiver may be deteriorated by being affected by a transmission path between a transmitter and the receiver. Therefore, there is a technique of improving communication quality by estimating information on the transmission path to remove the effect of the transmission path. A transmission path estimation method is generally used in which a known signal called a pilot signal common to a transmitter and a receiver is used between the transmitter and the receiver.

Japanese Patent No. 5645613 discloses a technique related to a transmission path estimation method. A transmitter places a pilot signal on a specific subcarrier. Then, the transmitter directly spreads the pilot signal, and transmits the pilot signal spread over a wide band. A receiver despreads the received pilot signal, extracts a subcarrier where the pilot signal exists, and performs transmission path estimation. Thus, the accuracy of transmission path estimation is improved.

However, according to the above-described conventional technique, there has been a problem that a delay wave may fail to be detected in signal detection before a pilot signal is extracted and thus, transmission path estimation accuracy may decrease.

The present disclosure has been made in view of the above, and an object of the present disclosure is to obtain a communication apparatus capable of improving transmission path estimation accuracy.

### SUMMARY OF THE INVENTION

To solve the above problem and achieve the object, a communication apparatus according to the present disclosure comprises: a despreading unit to perform despreading processing on a received signal subjected to direct spread processing; a signal detection unit to detect a plurality of signals included in the received signal subjected to the despreading processing; a delay amount estimation unit to estimate an amount of delay in each of the plurality of detected signals; a pilot signal extraction unit to extract a subcarrier including a pilot signal from the received signal on a basis of the estimated amounts of delay; a spreading unit to perform direct spread processing on the extracted pilot signal by using a spreading sequence used by a source of transmission of the received signal for performing direct spread processing; and a transmission path estimation processing unit to perform transmission path estimation processing on the basis of the pilot signal subjected to the direct spread processing.

### BRIEF DESCRIPTION OF THE DRAWINGS

FIG. 1 is a diagram illustrating a configuration of a communication system according to a first embodiment;

FIG. 2 is a diagram illustrating a functional configuration of a transmitter illustrated in FIG. 1;

FIG. 3 is a diagram illustrating a functional configuration of a receiver illustrated in FIG. 1;

FIG. 4 is a diagram showing an example of a detailed functional configuration of a transmission path estimation unit illustrated in FIG. 3;

FIG. 5 is a diagram illustrating a detailed functional configuration of a delay wave estimation unit illustrated in FIG. 4;

FIG. 6 is a diagram showing an example of a received signal spectrum subjected to FFT processing performed by a first signal detection unit illustrated in FIG. 5;

FIG. 7 is a diagram showing an example of a received signal spectrum subjected to FFT processing performed by a second signal detection unit illustrated in FIG. 5;

FIG. 8 is a diagram showing an example of a received signal spectrum subjected to FFT processing performed by the second signal detection unit illustrated in FIG. 5;

FIG. 9 is a diagram illustrating dedicated hardware for implementing respective functions of the transmitter and the receiver according to the first embodiment; and

FIG. 10 is a diagram illustrating a configuration of a control circuit for implementing the respective functions of the transmitter and the receiver according to the first embodiment.

### DETAILED DESCRIPTION OF THE PREFERRED EMBODIMENTS

Hereinafter, a communication apparatus, a communication system, a communication method, a control circuit, and a storage medium according to an embodiment of the present disclosure will be described in detail with reference to the drawings. Note that the technical scope of the present disclosure is not limited by the following embodiment.

### First Embodiment

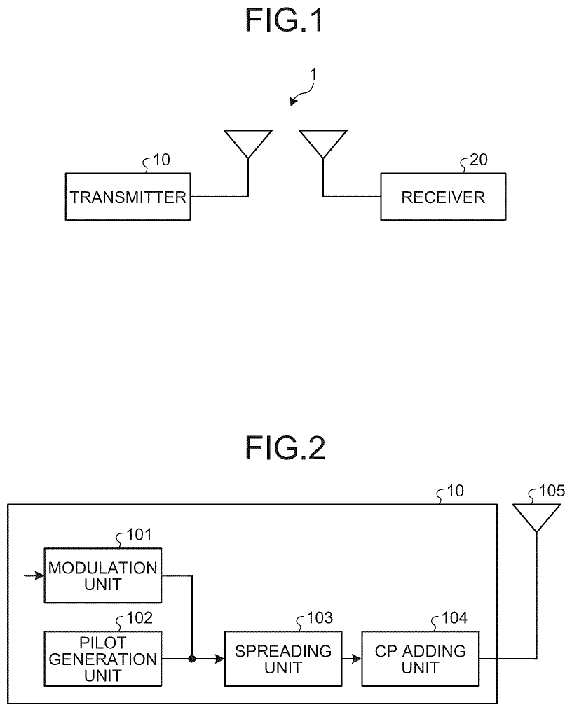

FIG. 1 is a diagram illustrating a configuration of a communication system 1 according to a first embodiment. The communication system 1 includes a transmitter 10 and a receiver 20. The transmitter 10 and the receiver 20 perform wireless communication by direct sequence spread spectrum using chirp spread spectrum. The receiver 20 improves communication quality by estimating a transmission path by use of a pilot signal.

The communication system 1 may perform wireless communication according to, for example, a wireless communication standard called LoRa. LoRa is a type of wireless communication standard for Internet of Things (IoT) in a wireless communication system called low power wide area (LPWA), and employs chirp spectrum spread (CSS) modulation that uses a chirp signal for spread spectrum. LPWA is attracting attention because LPWA enables low power consumption, a wide range of service areas, and low cost, and is suitable for a system, such as IoT and machine to machine (M2M), for communicating data such as sensor information. In such a spread spectrum system adopted in LoRa, spreading gain is obtained in association with a spreading ratio. As a result, reception sensitivity is high, and communication distance can be lengthened. However, communication speed is lowered by an increase in the spreading ratio. Therefore, such a spread spectrum system is suitable for a system in which a high communication speed is not required, such as IoT and M2M described above. Note that the communication system 1 is not limited to a system conforming to LoRa, and may be any system that performs spread spectrum.

FIG. 2 is a diagram illustrating a functional configuration of the transmitter 10 illustrated in FIG. 1. The transmitter 10 includes a modulation unit 101, a pilot generation unit 102, a spreading unit 103, a cyclic prefix (CP) adding unit 104, and a transmission antenna unit 105.

The modulation unit 101 performs modulation processing on data to be transmitted, and outputs the data subjected to the modulation processing to the spreading unit 103. The pilot generation unit 102 generates a pilot signal that is a predetermined known signal, and outputs the generated pilot signal to the spreading unit 103. The spreading unit 103 generates a transmission signal by performing direct spread processing of multiplying the modulated data output from the modulation unit 101 or the pilot signal output from the pilot generation unit 102 by a spreading sequence α(n). The spreading unit 103 outputs the transmission signal subjected to the direct spread processing to the CP adding unit 104. The spreading sequence α (n) is a chirp sequence having a spread length N, and it is possible to use a chirp sequence as shown in, for example, formula (1) below.

$$Formula 1$$

$$α ( n ) = exp \{ j \frac{π}{N} {Un}^{2} \} ( 0 \leq n \leq N - 1 ) \qquad ( 1 )$$

The chirp signal is characterized by frequency linearly changing with respect to time, and U in formula (1) is an integer representing the slope of frequency change in the chirp signal.

The CP adding unit 104 performs CP adding processing of adding, to the head of a transmission signal output from the spreading unit 103, a predetermined symbol located at the end of the transmission signal. The CP adding unit 104 outputs the transmission signal subjected to the CP adding processing to the transmission antenna unit 105. The transmission antenna unit 105 transmits, to the receiver 20, the transmission signal output from the CP adding unit 104.

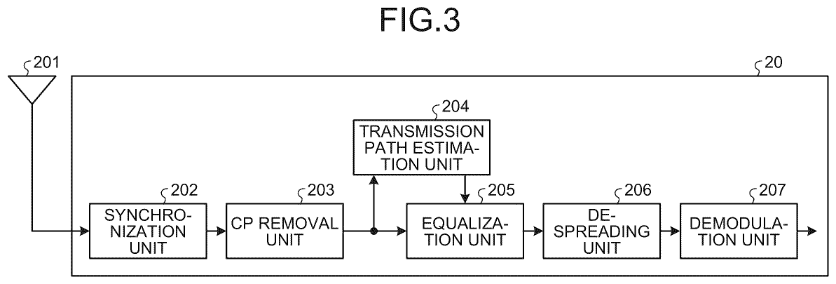

FIG. 3 is a diagram illustrating a functional configuration of the receiver 20 illustrated in FIG. 1. The receiver 20 includes a reception antenna unit 201, a synchronization unit 202, a CP removal unit 203, a transmission path estimation unit 204, an equalization unit 205, a despreading unit 206, and a demodulation unit 207.

The reception antenna unit 201 receives a signal transmitted by the transmitter 10, and outputs the received signal to the synchronization unit 202. The synchronization unit 202 estimates reception timing from a known sequence for synchronization included in the received signal, and performs synchronization processing on the basis of the estimated reception timing. The synchronization unit 202 outputs the received signal subjected to the synchronization processing to the CP removal unit 203. The CP removal unit 203 removes a CP added to the head of the received signal. In a case where a received signal to be processed includes a pilot signal, the CP removal unit 203 outputs the received signal to the transmission path estimation unit 204. Meanwhile, in a case where the received signal to be processed includes a data signal, the CP removal unit 203 outputs the received signal to the equalization unit 205.

The transmission path estimation unit 204 estimates transmission path information regarding a transmission path between the transmitter 10 and the receiver 20 on the basis of the pilot signal included in the received signal, and notifies the equalization unit 205 of the estimated transmission path information. A detailed function of the transmission path estimation unit 204 will be described below.

The equalization unit 205 performs equalization processing on the data signal included in the received signal by using the transmission path information provided from the transmission path estimation unit 204. The equalization unit 205 outputs the equalized data signal to the despreading unit 206.

The despreading unit 206 performs despreading processing by multiplying the data signal output from the equalization unit 205 by a complex conjugate of the spreading sequence α(n). The despreading unit 206 outputs the data signal subjected to the despreading processing to the demodulation unit 207.

The demodulation unit 207 performs demodulation processing on the data signal output from the despreading unit 206 to thereby extract pre-modulation data from the received signal.

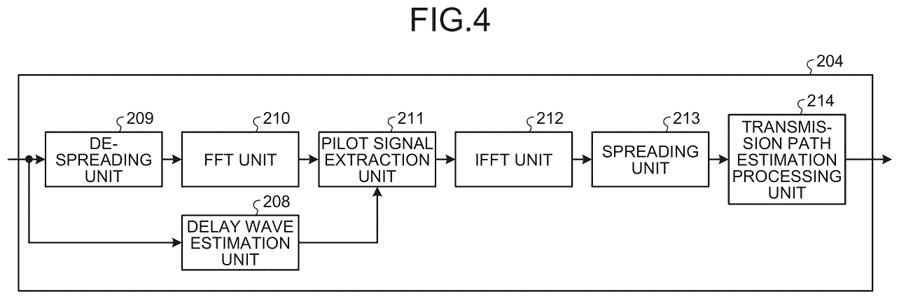

FIG. 4 is a diagram showing an example of a detailed functional configuration of the transmission path estimation unit 204 illustrated in FIG. 3. The transmission path estimation unit 204 includes a delay wave estimation unit 208, a despreading unit 209, a fast Fourier transform (FFT) unit 210, a pilot signal extraction unit 211, an inverse fast Fourier transform (IFFT) unit 212, a spreading unit 213, and a transmission path estimation processing unit 214. The received signal output from the CP removal unit 203 illustrated in FIG. 3 is input to each of the delay wave estimation unit 208 and the despreading unit 209 of the transmission path estimation unit 204.

The delay wave estimation unit 208 detects a plurality of signals that are preceding waves or delay waves included in the received signal, and estimates an amount of delay in each of the plurality of detected signals. The delay wave estimation unit 208 outputs delay amount information indicating the estimated delay amounts to the pilot signal extraction unit 211. Detailed processing to be performed by the delay wave estimation unit 208 will be described below.

The despreading unit 209 performs despreading processing by multiplying the received signal by the complex conjugate of the spreading sequence α(n). The despreading unit 209 outputs the received signal subjected to the despreading processing to the FFT unit 210.

The FFT unit 210 converts the received signal in a time domain into a frequency domain signal by performing Fourier transform processing at N points on the received signal subjected to the despreading processing. The FFT unit 210 outputs the received signal in the frequency domain subjected to the Fourier transform processing to the pilot signal extraction unit 211.

The pilot signal extraction unit 211 extracts a pilot signal from the received signal output from the FFT unit 210 by performing zero padding processing on a subcarrier other than a subcarrier where a signal exists, and outputs the processed pilot signal to the IFFT unit 212. At this time, the pilot signal extraction unit 211 determines a subcarrier number of the subcarrier where the signal exists based on the delay amount information output from the delay wave estimation unit 208. When subcarrier numbers are “0” to “N−1” and the delay amount information output from the delay wave estimation unit 208 indicates a delay amount of t chips for a certain delay wave, the pilot signal extraction unit 211 determines a subcarrier number of a subcarrier where the delay wave exists as follows. First, when the delay amount τ is an integer value, the pilot signal extraction unit 211 determines that the delay wave exists on an (N−τ)th subcarrier. When the delay amount τ is a non-integer value, the pilot signal extraction unit 211 determines that the delay wave exists on an n₁-th subcarrier and an n₂-th subcarrier, where n₁ is a value obtained by subtraction of the floor function of τ from N and n₂ is a value obtained by subtraction of the ceiling function of t ƒrom N. The floor function of τ is a function that returns a maximum integer not exceeding τ, and the ceiling function of τ is a function that returns a minimum integer that is not less than τ.

The IFFT unit 212 performs inverse Fourier transform processing on the pilot signal extracted by the pilot signal extraction unit 211 at N points, to convert the pilot signal in the frequency domain into a signal in the time domain. The IFFT unit 212 outputs the pilot signal subjected to the inverse Fourier transform processing to the spreading unit 213.

The spreading unit 213 performs direct spread processing by multiplying the pilot signal in the time domain by the spreading sequence α(n). The spreading unit 213 outputs the pilot signal subjected to the direct spread processing to the transmission path estimation processing unit 214.

The transmission path estimation processing unit 214 estimates transmission path information regarding the frequency domain from the pilot signal output from the spreading unit 213. Since the pilot signal is a known signal, the transmission path estimation processing unit 214 can estimate transmission path information by using the received pilot signal and a pilot signal despread at the time of transmission. For example, a received pilot signal is converted into that in the frequency domain by use of FFT, rₘ denotes a signal of an m-th subcarrier of the received pilot signal, and xₘ denotes a signal of an m-th subcarrier of a pilot signal despread at the time of transmission in the transmitter 10 and converted into that in the frequency domain. At this time, it is possible to obtain a transmission path hₘ of the m-th subcarrier by subtracting xm from rm. Note that although FIG. 4 illustrates the configuration including the transmission path estimation processing unit 214 that estimates transmission path information regarding the frequency domain, another method may be used as a transmission path estimation method.

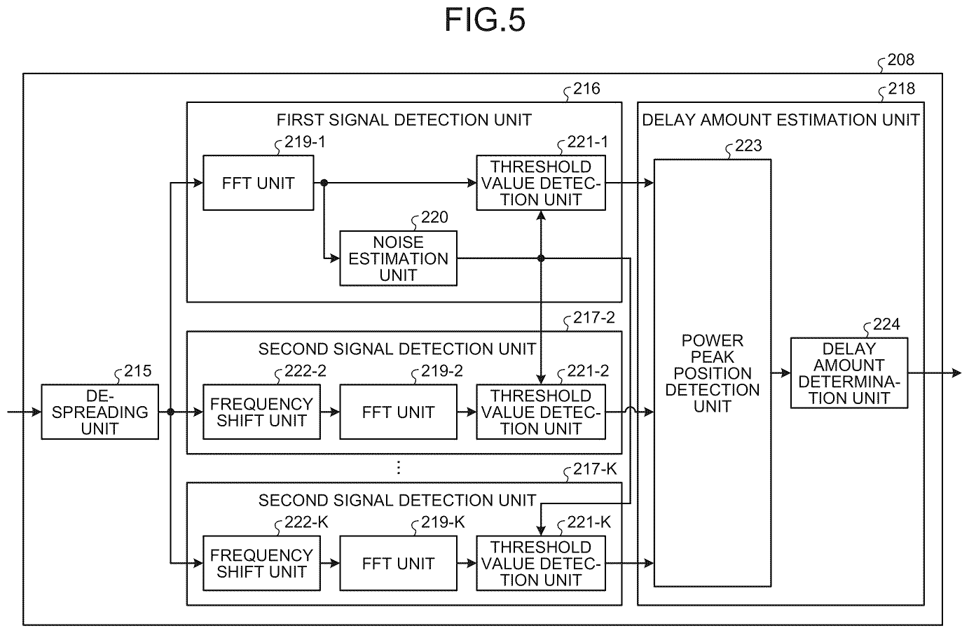

FIG. 5 is a diagram illustrating a detailed functional configuration of the delay wave estimation unit 208 illustrated in FIG. 4. The delay wave estimation unit 208 includes a despreading unit 215, a first signal detection unit 216, a plurality of second signal detection units 217-2 to 217-K, and a delay amount estimation unit 218. Note that when it is not necessary to distinguish between the second signal detection units 217-2 to 217-K in the following description, the second signal detection units 217-2 to 217-K may be simply referred to as second signal detection units 217.

The despreading unit 215 performs despreading processing by multiplying the received signal by the complex conjugate of the spreading sequence α(n). The despreading unit 215 outputs the received signal subjected to the despreading processing to each of the first signal detection unit 216 and the plurality of second signal detection units 217.

The first signal detection unit 216 includes an FFT unit 219-1, a noise estimation unit 220, and a threshold value detection unit 221-1. Each of the plurality of second signal detection units 217 includes a frequency shift unit 222, an FFT unit 219, and a threshold value detection unit 221. Specifically, the second signal detection unit 217-2 includes a frequency shift unit 222-2, an FFT unit 219-2, and a threshold value detection unit 221-2. The same applies to the second signal detection units 217-3 to 217-K. The delay amount estimation unit 218 includes a power peak position detection unit 223 and a delay amount determination unit 224.

The FFT unit 219 performs Fourier transform at N points on a received signal having been input, to convert the received signal into a frequency domain signal. The received signal output from the despreading unit 215 is directly input to the FFT unit 219-1 of the first signal detection unit 216. Received signals processed by frequency shift units 222-2 to 222-K are input to FFT units 219-2 to 219-K of the second signal detection units 217-2 to 217-K, respectively. The FFT unit 219-1 outputs the received signal converted into a frequency domain signal to each of the noise estimation unit 220 and the threshold value detection unit 221-1. The FFT units 219-2 to 219-K output the received signals converted into frequency domain signals to threshold value detection units 221-2 to 221-K, respectively.

The noise estimation unit 220 estimates noise power from the received signal output from the FFT unit 219-1, and outputs the estimated noise power to each of the threshold value detection units 221-1 to 221-K. The noise estimation unit 220 can measure the power of a subcarrier where no signal exists, and use an average of the measured power in the subcarrier as the noise power. In the first embodiment, since no signal exists on subcarriers within a CP length, the noise estimation unit 220 can measure the power of the subcarriers within the CP length and use an average of the measured power of the subcarriers as the noise power. In a case where the CP length is L, the noise estimation unit 220 measures the power of each of subcarriers having subcarrier numbers “1” to “N−L−1”, and estimates noise power.

The frequency shift unit 222 performs phase rotation on the received signal in the time domain subjected to the despreading processing by the despreading unit 215, by a shift amount of a non-integral multiple of a spreading period, that is, a shift amount corresponding to a value between 0 and 1 chips. The shift amount to be used here differs for each of the frequency shift units 222-2 to 222-K. The frequency shift unit 222 multiplies the received signal subjected to the despreading processing by exp(jθ), where θ is a shift amount. A shift amount θᵢ of a second signal detection unit 222-i is expressed by formula (2) below, where B_{c}[Hz] is a chip rate.

$$Formula 2$$

$${θ}_{i} = {iB}_{c} / N ( K + 1 ) \qquad ( 2 )$$

The frequency shift units 222-2 to 222-K output the received signals subjected to the phase rotation processing to the FFT units 219-2 to 219-K, respectively. Therefore, the received signals subjected to the phase rotation processing in the frequency shift units 222-2 to 222-K are converted into frequency domain signals in the FFT units 219-2 to 219-K, and then output to the threshold value detection units 221-2 to 221-K, respectively.

The threshold value detection unit 221 calculates the power of each subcarrier from the received signal in the frequency domain output from the FFT unit 219, and determines whether the power of each subcarrier exceeds a threshold value. The threshold value detection unit 221 determines that a subcarrier with power exceeding the threshold value is a subcarrier where a signal exists, and notifies the power peak position detection unit 223 of a subcarrier number for identifying the subcarrier with power exceeding the threshold value and the power of the subcarrier. A value obtained by multiplication of the noise power provided from the noise estimation unit 220 by any coefficient can be used as the threshold value here. Note that even when the threshold value is exceeded for a signal appearing outside the CP length, a determination of “not detected” is made in determination as to the threshold value. This is because when an amount of delay in the delay wave is within the CP length, pilot signals appear in subcarriers having the subcarrier number “0” and subcarrier numbers “N−1” to “N−L”, and no pilot signal exists in any other subcarriers.

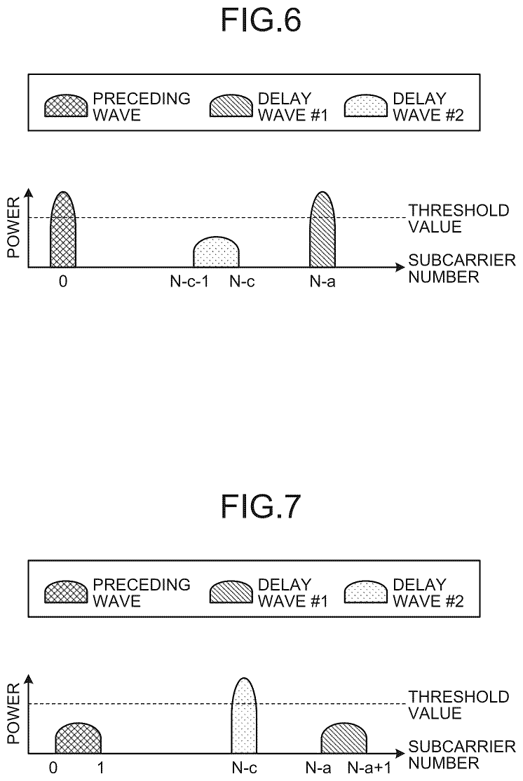

FIG. 6 is a diagram showing an example of a received signal spectrum subjected to FFT processing performed by the first signal detection unit 216 illustrated in FIG. 5. Here, an example in which two delay waves exist is shown. Assume that amounts of delay in a delay wave #1 and a delay wave #2 are “a” chips and “b” chips, respectively, such that the delay amount “a” is an integral multiple of a chip time rate 1/N, and the delay amount “b” is a non-integral multiple of the chip time rate 1/N. Here, b=c+d, where c is an integer part of b, and d is a fractional part of b. In the example shown in FIG. 6, the threshold value detection unit 221-1 of the first signal detection unit 216 detects a preceding wave and the delay wave #1, which are signals exceeding the threshold value, and notifies the power peak position detection unit 223 of subcarrier numbers “0” and “N−a” of the detected signals and the power of these subcarriers.

FIG. 7 is a diagram showing an example of a received signal spectrum subjected to FFT processing performed by a second signal detection unit 217-i illustrated in FIG. 5. In this case, a threshold value detection unit 221-i of the second signal detection unit 217-i detects the delay wave #2 exceeding the threshold value, and notifies the power peak position detection unit 223 of a subcarrier number “N−c” of the detected signal and the power of this subcarrier.

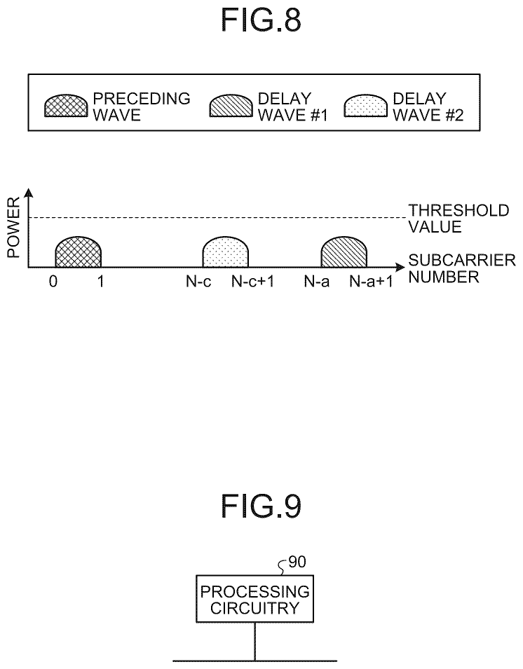

FIG. 8 is a diagram showing an example of a received signal spectrum subjected to FFT processing performed by the second signal detection unit 217-K illustrated in FIG. 5. In this case, since there is no signal exceeding the threshold value, the threshold value detection unit 221-K of the second signal detection unit 217-K notifies the power peak position detection unit 223 that there is no signal exceeding the threshold value.

Based on the information provided from each of the first signal detection unit 216 and the second signal detection units 217-2 to 217-K, the power peak position detection unit 223 notifies the delay amount determination unit 224 of the subcarrier numbers of the subcarriers where signals have been detected and numbers assigned to the signal detection units corresponding to the subcarrier numbers, the assigned numbers serving as identification information for specifying the signal detection units. Here, a signal detection unit corresponding to a subcarrier number is a signal detection unit that has notified the power peak position detection unit 223 of the subcarrier number, and is the first signal detection unit 216 or any of the second signal detection unit 217-2 to 217-K. In addition, a number assigned to the first signal detection unit 216 is “#1”, and numbers assigned to the second signal detection units 217 are “#2 to #K”. When subcarrier numbers provided from the threshold value detection units 221-1 to 221-K overlap, the power peak position detection unit 223 notifies the delay amount determination unit 224 of a number for specifying a signal detection unit corresponding to the largest power, notification of which has been provided to the power peak position detection unit 223, among a plurality of signal detection units corresponding to the subcarrier number.

For example, when the power peak position detection unit 223 are notified of detection results illustrated in FIGS. 6 to 8, the power peak position detection unit 223 notifies the delay amount determination unit 224 of the subcarrier numbers “0” and “N−a”, the number “#1” assigned to the signal detection unit, the subcarrier number “N-c”, and a number “#i” assigned to the signal detection unit.

The delay amount determination unit 224 estimates the amount of delay in each of the plurality of signals included in the received signal on the basis of the information provided from the power peak position detection unit 223, and notifies the pilot signal extraction unit 211 of delay amount information indicating estimation results. The method for delay amount estimation differs between the first signal detection unit 216 and the second signal detection units 217. The delay amount determination unit 224 sets an amount of delay in a subcarrier detected by the first signal detection unit 216 to a delay amount of “0” when the subcarrier number is “0”, and calculates a delay amount by using formula (3) below when the subcarrier number is other than “0”.

$$Formula 3$$

$$Delay amount = - ( Subcarrier number ) + N \qquad ( 3 )$$

When the subcarrier number is “0”, the delay amount determination unit 224 calculates the amount of delay in a subcarrier detected by the second signal detection unit 217-i by using formula (4) below, and when the subcarrier number is other than “0”, the delay amount determination unit 224 calculates the amount of delay in the subcarrier by using formula (5) below. The symbol “i” denotes a number assigned to the signal detection unit, and takes a value from 2 to K.

$$Formula 4 :$$

$$Delay amount = i / ( K + 1 ) \qquad ( 4 )$$

$$Formula 5 :$$

$$Delay amount = - ( Subcarrier number ) + N + i / ( K + 1 ) \qquad ( 5 )$$

That is, the delay amount is “−(N−a)+N=a” chips when notification of the subcarrier number “N−a” has been provided from the first signal detection unit 216, and the delay amount is “−(N−c)+N+i/(K+1)” chips when notification of the subcarrier number “N−c” has been provided from the second signal detection unit 217-i.

Next, a hardware configuration of the transmitter 10 and the receiver 20 according to the first embodiment will be described. Each function of the transmitter 10 and the receiver 20 is implemented by processing circuitry. The processing circuitry may be implemented by dedicated hardware, or may be a control circuit using a central processing unit (CPU).

When implemented by dedicated hardware, the above-described processing circuitry is implemented by processing circuitry 90 illustrated in FIG. 9. FIG. 9 is a diagram illustrating dedicated hardware for implementing respective functions of the transmitter 10 and the receiver 20 according to the first embodiment. The processing circuitry 90 is a single circuit, a composite circuit, a programmed processor, a parallel-programmed processor, an application specific integrated circuit (ASIC), a field programmable gate array (FPGA), or a combination thereof.

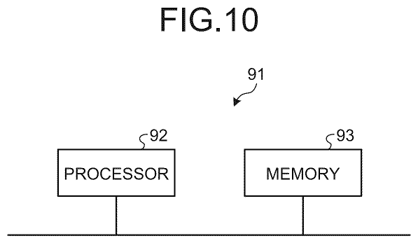

In a case where the above-described processing circuitry is implemented by a control circuit using a CPU, this control circuit is, for example, a control circuit 91 with a configuration illustrated in FIG. 10. FIG. 10 is a diagram illustrating a configuration of the control circuit 91 for implementing the respective functions of the transmitter 10 and the receiver 20 according to the first embodiment. As illustrated in FIG. 10, the control circuit 91 includes a processor 92 and a memory 93. The processor 92 is a CPU, and is also called an arithmetic device, a microprocessor, a microcomputer, a digital signal processor (DSP), or the like. Examples of the memory 93 include nonvolatile or volatile semiconductor memories such as a random access memory (RAM), a read only memory (ROM), a flash memory, an erasable programmable ROM (EPROM), and an electrically EPROM (EEPROM (registered trademark)), a magnetic disk, a flexible disk, an optical disk, a compact disk, a mini disk, and a digital versatile disk (DVD).

In a case where the above-described processing circuitry is implemented by the control circuit 91, the processing circuitry is implemented by the processor 92 reading and executing a program corresponding to a process of each constituent element, stored in the memory 93. The memory 93 is also used as a temporary memory in each process executed by the processor 92. Note that the program to be executed by the processor 92 may be provided by being stored in a storage medium, or may be provided via a communication path.

In addition, each function of the transmitter 10 may be implemented such that respective functions of a plurality of blocks illustrated in FIG. 2 are implemented by different processing circuitry, a function of a single block is divided and implemented by a plurality of pieces of processing circuitry, or functions of a plurality of blocks are collectively implemented by a single piece of processing circuitry. The same applies to the receiver 20, and each function of the receiver 20 may be implemented such that respective functions of a plurality of blocks illustrated in FIGS. 3 to 5 are implemented by different processing circuitry, a function of a single block is divided and implemented by a plurality of pieces of processing circuitry, or functions of a plurality of blocks are collectively implemented by a single piece of processing circuitry.

The communication apparatus according to the present disclosure has an effect of enabling transmission path estimation accuracy to be improved.

The configurations set forth in the above embodiment show examples, and it is possible to combine the configurations with another known technique or combine the embodiment with another embodiment, and is also possible to partially omit or change the configurations without departing from the scope of the present disclosure.

What is claimed is:

1. A communication apparatus comprising:
despreading circuitry to perform despreading processing on a received signal subjected to direct spread processing;
signal detection circuitry to detect a plurality of signals included in the received signal subjected to the despreading processing;
delay amount estimation circuitry to estimate an amount of delay in each of the plurality of detected signals;
pilot signal extraction circuitry to extract a subcarrier including a pilot signal from the received signal on a basis of the estimated amounts of delay;
spreading circuitry to perform direct spread processing on the extracted pilot signal by using a spreading sequence used by a source of transmission of the received signal for performing direct spread processing; and
transmission path estimation processing circuitry to perform transmission path estimation processing on the basis of the pilot signal subjected to the direct spread processing.

2. The communication apparatus according to claim 1, wherein
the signal detection circuitry includes a plurality of signal detection circuits,
the plurality of signal detection circuits includes:
a first signal detection circuit including a frequency conversion circuit and a threshold value detection circuit, the frequency conversion circuit converting the received signal subjected to despreading processing in a time domain into the received signal in a frequency domain, the threshold value detection circuit detecting any of a plurality of subcarriers of the received signal converted into the frequency domain, power of any subcarrier detected exceeding a threshold value; and
a plurality of second signal detection circuits each including a frequency shift circuit, the frequency conversion circuit, and the threshold value detection circuit, the frequency shift circuit performing phase rotation, by a shift amount, on the received signal in the time domain subjected to the despreading processing, the shift amount being a non-integral multiple of a spreading period and different for each of the signal detection circuits, the received signal subjected to the phase rotation being input to the frequency conversion circuit.

3. The communication apparatus according to claim 2, wherein
each of a plurality of the threshold value detection circuits notifies the delay amount estimation circuit of subcarrier information and power of a subcarrier exceeding the threshold value, the subcarrier information specifying the subcarrier with the power exceeding the threshold value, and
the delay amount estimation circuit includes:
a power peak position detection circuit to detect identification information specifying the signal detection circuit having detected maximum power for each subcarrier, on the basis of information of which each of the plurality of threshold value detection circuits has notified the power peak position detection circuit; and
a delay amount determination circuit to determine an amount of delay in each of a plurality of signals included in the received signal, on the basis of the identification information and a position of the subcarrier with power exceeding the threshold value.

4. A communication system comprising:
a transmitter to directly spread and transmit a pilot signal; and
a receiver to receive the signal transmitted by the transmitter, the receiver being the communication apparatus according to claim 1.

5. A communication system comprising:
a transmitter to directly spread and transmit a pilot signal; and
a receiver to receive the signal transmitted by the transmitter, the receiver being the communication apparatus according to claim 2.

6. A communication system comprising:
a transmitter to directly spread and transmit a pilot signal; and
a receiver to receive the signal transmitted by the transmitter, the receiver being the communication apparatus according to claim 3.

7. A communication method comprising:
performing despreading processing on a received signal subjected to direct spread processing;
detecting a plurality of signals included in the received signal subjected to the despreading processing;
estimating an amount of delay in each of the plurality of detected signals;
extracting a subcarrier including a pilot signal from the received signal on a basis of the estimated amounts of delay;
performing direct spread processing on the extracted pilot signal by using a spreading sequence used by a source of transmission of the received signal for performing direct spread processing; and
performing transmission path estimation processing on the basis of the pilot signal subjected to the direct spread processing.

8. A control circuit to control a communication apparatus,
the control circuit causing the communication apparatus to execute:
performing despreading processing on a received signal subjected to direct spread processing;
detecting a plurality of signals included in the received signal subjected to the despreading processing;
estimating an amount of delay in each of the plurality of detected signals;
extracting a subcarrier including a pilot signal from the received signal on a basis of the estimated amounts of delay;
performing direct spread processing on the extracted pilot signal by using a spreading sequence used by a source of transmission of the received signal for performing direct spread processing; and
performing transmission path estimation processing on the basis of the pilot signal subjected to the direct spread processing.

9. A non-transitory storage medium storing a program to control a communication apparatus, the program causing the communication apparatus to execute:
performing despreading processing on a received signal subjected to direct spread processing;
detecting a plurality of signals included in the received signal subjected to the despreading processing;
estimating an amount of delay in each of the plurality of detected signals;
extracting a subcarrier including a pilot signal from the received signal on a basis of the estimated amounts of delay;
performing direct spread processing on the extracted pilot signal by using a spreading sequence used by a source of transmission of the received signal for performing direct spread processing; and
performing transmission path estimation processing on the basis of the pilot signal subjected to the direct spread processing.
